(19) United States
(12) Patent Application Publication
(10) Pub. No.: US 2016/0032886 A1
(43) Pub. Date: Feb. 4, 2016

(54) WAVE POWER ELECTRICITY GENERATION DEVICE

(71) Applicant: Hui-Hsiung YANG, Kaohsiung City (TW)

(72) Inventor: Hui-Hsiung YANG, Kaohsiung City (TW)

(21) Appl. No.: 14/811,197

(22) Filed: Jul. 28, 2015

(30) Foreign Application Priority Data
Jul. 30, 2014 (TW) 103126051

(51) Int. Cl. F03B 13/18

(52) U.S. Cl. CPC F03B 13/1815

(57) ABSTRACT

A wave power electricity generation device includes a base unit, an electricity generation unit mounted on the base unit, a driving unit and a pneumatic unit. The driving unit is pivoted to the base unit, and includes a floating frame and a swing arm that is pivoted to the base unit and that interconnects the electricity generation unit and the floating frame. The driving unit is adapted to be driven by waves to drive operation of the electricity generation unit and to actuate operation of the pneumatic unit for compressing air into high pressure air that is to be stored in the floating frame. The high pressure air is released to actuate the electricity generation unit when the electricity generation unit is unable to be driven due to insufficient waves.

### CROSS-REFERENCE TO RELATED APPLICATION

This application claims priority of Taiwanese Application No. 103126051, filed on Jul. 30, 2014.

### FIELD

The disclosure relates to an electricity generation device, more particularly to a wave power electricity generation device.

### BACKGROUND

As technology advances, the demand for energy is increasing. Because ocean covers 70% of the Earth's surface, the wave power that ocean waves possess is a useful renewable energy with great potentials.

At the moment, there are four types of wave electricity generation system: oscillating water column type, tidal stream type, lever type and Pelamis type. The oscillating water column type is driven by the up-and-down motion of water column in a vertical well or a caisson caused by waves, the disadvantage of which being that the electricity generating efficiency of air vane is low and unstable. The tidal stream type converts potential energy of tidal range into electrical energy. However, this type of system suffers from limited sites with sufficient tidal range. The lever type generally includes a float connected to a lever and fluctuating along with the fluctuation of waves, thereby driving pivot action of the lever to actuate a power generator which is connected to the lever. The disadvantage of this type is unstable electricity generation especially when the fluctuation of waves is small. Pelamis is driven by hydraulic motors, however, this device needs to be set up at particular sea areas and is difficult to be maintained.

Referring to FIG. 1, Taiwanese Utility Model Patent No. M401062 discloses a conventional wave power electricity generation device 1 that includes a fixing frame 11, an electricity generator 12 that is mounted on the fixing frame 11, a lever 13 that is connected to the electricity generator 12, and a float 14 that is connected to an end of the lever 13.

The lever 13 swings up and down and drives the electricity generator 12 to generate electrical energy when the waves push the float 14.

However, the electricity generating efficiency of the conventional wave power electricity generation device 1 is unstable and relatively low, particularly when there are insufficient waves to drive the electricity generator 12.

### SUMMARY

Therefore, the object of the disclosure is to provide a wave power electricity generation device that is able to steadily generate electrical energy.

Accordingly, a wave power electricity generation device of the present disclosure includes a base unit, an electricity generation unit, a driving unit and a pneumatic unit. The electricity generation unit is mounted on the base unit and is operable for converting mechanical energy into electrical energy. The driving unit is pivoted to the base unit and is connected to the electricity generation unit. The driving unit includes a floating frame and a swing arm. The swing arm is pivoted to the base unit, and has an end that is connected to the electricity generation unit, and an opposite end that is connected to the floating frame. The pneumatic unit is connected to the electricity generation unit and the driving unit. The driving unit is adapted to be driven by waves to drive operation of the electricity generation unit and to actuate operation of the pneumatic unit for compressing air into high pressure air and delivering the high pressure air into the floating frame. The high pressure air is released to drive operation of the electricity generation unit when the electricity generation unit is unable to be driven due to insufficient waves.

### BRIEF DESCRIPTION OF THE DRAWINGS

Other features and advantages of the disclosure will become apparent in the following detailed description of the embodiment with reference to the accompanying drawings, of which:

FIG. 1 is a side view of a conventional wave power electricity generation device disclosed in Taiwanese Utility Model Patent No. M401062;

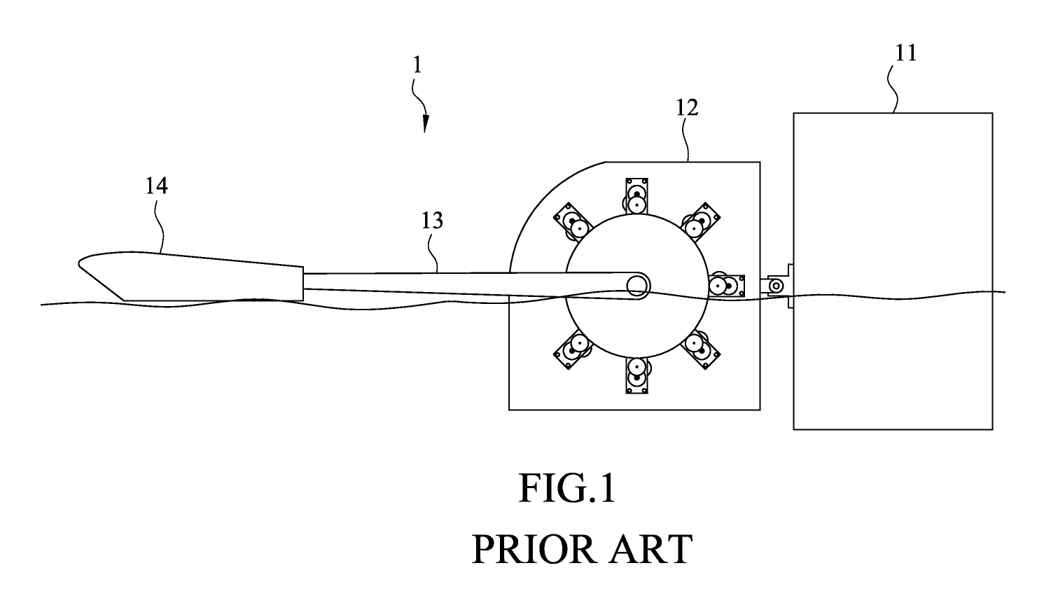

FIG. 2 is a perspective view of an embodiment of a wave power electricity generation device according to the present disclosure;

FIG. 3 is a side view of the embodiment; and

FIG. 4 is a schematic diagram illustrating an operating process of the embodiment.

### DETAILED DESCRIPTION

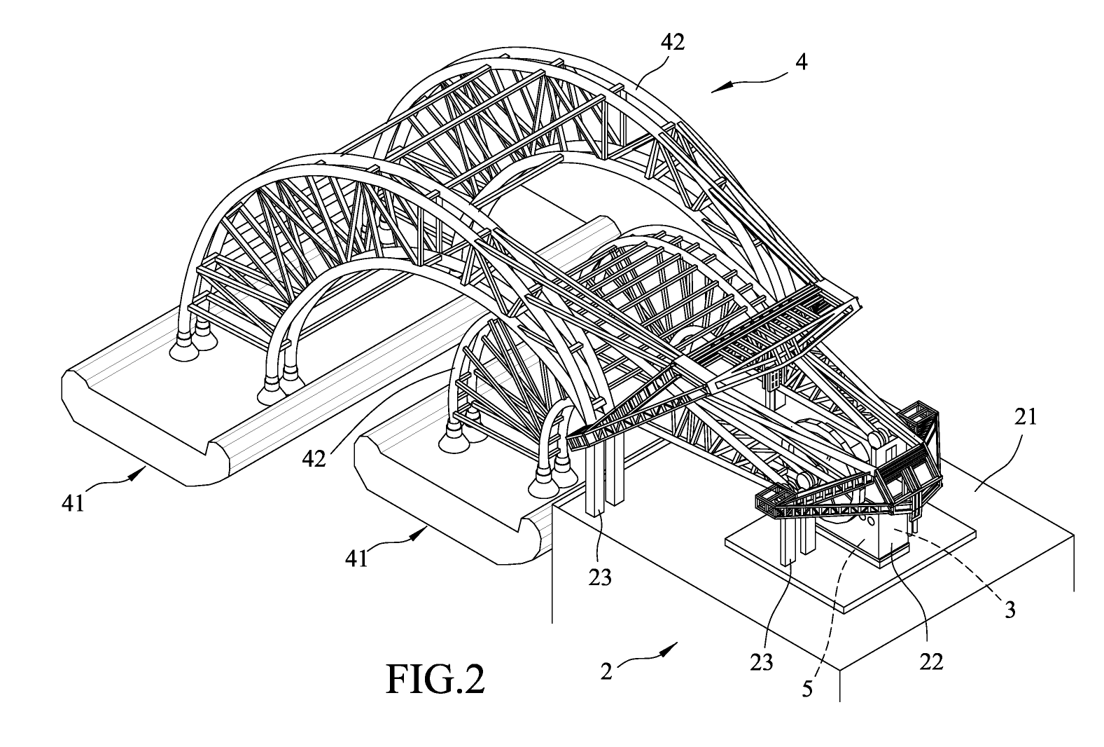

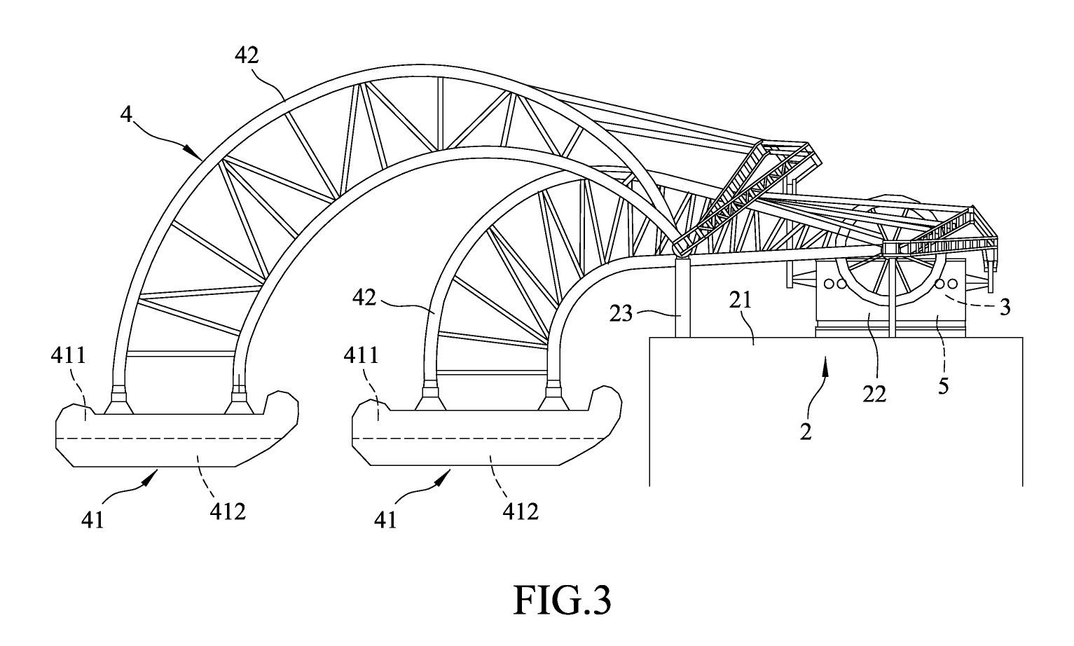

As shown in FIGS. 2 and 3, the embodiment of a wave power electricity generation device according to the present disclosure includes a base unit 2, an electricity generation unit 3 mounted on the base unit 2 and operable for converting mechanical energy into electrical energy, a driving unit 4 pivoted to the base unit 2 and connected to the electricity generation unit 3, and a pneumatic unit 5 connected to the electricity generation unit 3 and the driving unit 4. In this embodiment, the base unit 2 includes a base seat 21, a retaining box 22 mounted on the base seat 21 and retaining the electricity generation unit 3 and the pneumatic unit 5, and a plurality of brackets 23 mounted on the base seat 21. In this embodiment, the electricity generation unit 3 uses a gear set (not shown) to transfer input mechanical energy and drive operation of an electricity generator (not shown). The foregoing gear set adopts unidirectional motion design to continuously transfer energy.

In this embodiment, the driving unit 4 includes two floating frames 41 that are spaced apart from each other, and two swing arms 42 that are pivoted respectively to the brackets 23 of the base unit 2. Each of the swing arms 42 has an end that is connected to the electricity generation unit 3, and an opposite end that is connected to a respective one of the floating frames 41. Each of the floating frames 41 has a tank portion 411 connected to the respective one of the swing arms 42 and a weight portion 412 disposed under the tank portion 411 and adapted to retain a weight element (not shown).

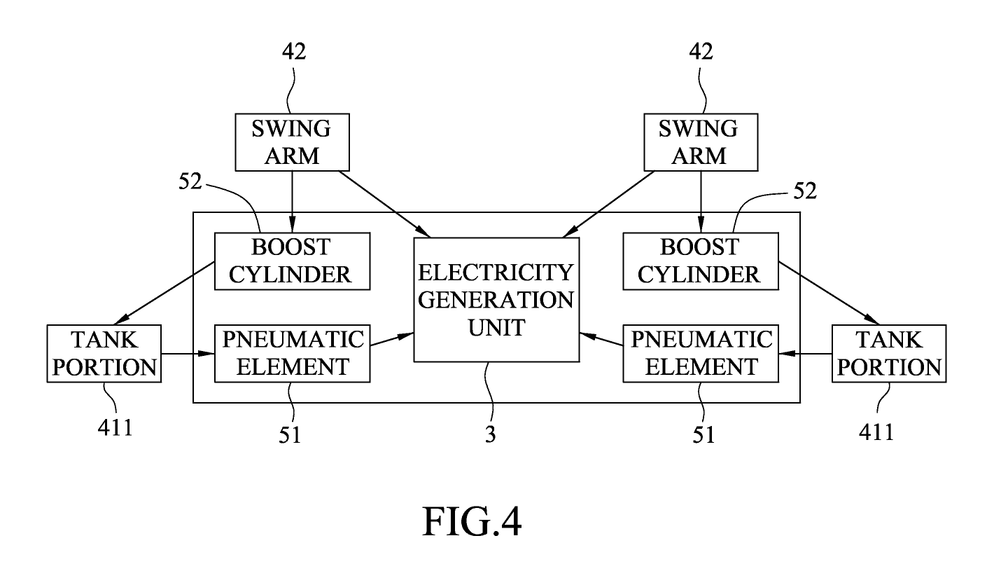

Referring to FIGS. 3 and 4, the pneumatic unit 5 includes two pneumatic elements 51 connected to the electricity generation unit 3 and communicating fluidly and respectively the tank portions 411 of the floating frames 41, two boost cylinders 52 connected respectively to the swing arms 42 of the driving unit 4 and communicating fluidly and respectively the tank portions 411 of the floating frames 41.

In use, each one of the floating frames 41 fluctuates up and down with waves and drives the respective one of the swing arms 42 so that the respective one of the swing arms 42 is able to pivot and drive operation of the electricity generation unit 3 for generating electrical energy. During the pivot movement of the swing arms 42, the boost cylinders 52 are actuated to compress air into high pressure air and deliver the high pressure air into the tank portions 411 of the floating frames 41. When there are insufficient waves to drive the swing arms 42, the high pressure air is released from the tank portions 411 of the floating frames 41 to initiate the respective one of the pneumatic elements 51 to drive operation of the electricity generation unit 3 for ensuring stable electricity generation.

In addition, a water level sensor module (not shown) may be provided to sense water fluctuation, and a measuring module (not shown) may be provided to detect the electricity generating efficiency to judge whether to release high pressure air to assist any one of the swing arms 42 to drive the electricity generation unit 3. It should be noted that the judging method is not limited to involving the foregoing modules and may vary in other embodiments.

The swing arms 42 are configured not to intervene each other and to be able to convert unstable waves into vertical swinging kinetic energy. The unidirectional motion design of the gear set of the electricity generation unit 3 is able to continuously output power to drive the electricity generation unit 3. Furthermore, since the swinging arms 42 are pivotable, the floating frames 41 are able to remain stably on sea surface under irregular fluctuation.

In conclusion, by virtue of the abovementioned configuration which is different from the four types of the conventional wave power electricity generation devices, the electricity generation unit 3 can be driven by the movements of the floating frames 41 and the swing arms 42, or be driven by the pneumatic unit 5 under the condition that the swinging energy of the driving unit is not enough, thereby allowing the electricity generation unit 3 to be able to steadily generate electrical energy and increase electricity generating efficiency.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A wave power electricity generation device comprising:
a base unit;
an electricity generation unit mounted on said base unit and operable for converting mechanical energy into electrical energy;
a driving unit pivoted to said base unit and connected to said electricity generation unit, said driving unit including a floating frame, and a swing arm that is pivoted to said base unit, and that has an end connected to said electricity generation unit, and an opposite end connected to said floating frame; and
a pneumatic unit connected to said electricity generation unit and said driving unit, said driving unit being adapted to be driven by waves to drive operation of said electricity generation unit and to actuate operation of said pneumatic unit for compressing air into high pressure air and delivering the high pressure air into said floating frame, the high pressure air being released to drive operation of said electricity generation unit when said electricity generation unit is unable to be driven due to insufficient waves.

2. The wave power electricity generation device as claimed in claim 1, wherein said pneumatic unit includes:
a boost cylinder connected to said swing arm of said driving unit, communicating fluidly said floating frame of said driving unit, and operable to compress the air into the high pressure air; and
a pneumatic element connected to said electricity generation unit, communicating fluidly said floating frame of said driving unit, and operable to drive operation of said electricity generation unit when said electricity generation unit is unable to be driven due to insufficient waves.

3. The wave power electricity generation device as claimed in claim 2, wherein said floating frame has a tank portion connected to said swing arm and adapted to store the high pressure air, and a weight portion disposed under said tank portion.

4. The wave power electricity generation device as claimed in claim 1, wherein said base unit includes a base seat, a retaining box mounted on said base seat and retaining said electricity generation unit and said pneumatic unit, and a bracket mounted on said base seat, said swing arm being pivoted to said bracket.

5. The wave power electricity generation device as claimed in claim 2, wherein said base unit includes a base seat, a retaining box mounted on said base seat and retaining said electricity generation unit and said pneumatic unit, and a bracket mounted on said base seat, said swing arm being pivoted to said bracket.

6. The wave power electricity generation device as claimed in claim 3, wherein said base unit includes a base seat, a retaining box mounted on said base seat and retaining said electricity generation unit and said pneumatic unit, and a bracket mounted on said base seat, said swing arm being pivoted to said bracket.
